(19) United States
(12) Patent Application Publication
(10) Pub. No.: US 2003/0142402 A1
(43) Pub. Date: Jul. 31, 2003

(54) Method and apparatus for triggering a remote flash on a camera with a panoramic lens

(75) Inventors: Jorge E. Carbo JR., Redwood City, CA (US); Edward C. Driscoll JR., Portola Valley, CA (US)

Correspondence Address: BEVER, HOFFMAN & HARMS, LLP, 1432 CONCANNON BLVD., BLDG. G, LIVERMORE, CA, 94550, US

(73) Assignee: Be Here Corporation, Cupertino, CA (US)

(21) Appl. No.: 10/066,135

(22) Filed: Jan. 30, 2002

(51) Int. Cl. G02B 1/00; H04N 5/225

(52) U.S. Cl. 359/509; 358/909.1

(57) ABSTRACT

A panoramic flash system is disclosed that filters out visible light (but not invisible light) from a flash unit that is directly connected to a camera equipped with a panoramic lens. The invisible light is then used to trigger a remote flash located in a blind spot of the field of view of the panoramic lens. The remote flash then illuminates the scene within the field-of-view of the panoramic lens. The visible-light filter can be an adhesive tape that is placed over the lens of a flash unit that is integral with the camera body. The panoramic lens can have the remote flash unit attached to the lens in the lens' blind spot.

### BACKGROUND OF THE INVENTION

1. Field of the Invention

This invention relates to the field of panoramic flash photography.

2. Background

Many digital and film cameras have an integral flash within the body of the camera. These cameras can be used with a panoramic optical system to provide a “one-shot” panoramic capture solution. One-shot solutions to capturing a panoramic image often use a lens that extends out from the camera such that the camera is not pointed at the panorama, but is pointed perpendicular to the horizon line of the panorama. Thus, the image is captured around the camera. One example of such a configuration is that disclosed in U.S. Pat. No. 5,760,826 to Nayar and illustrated by FIG. 1. Here a one-shot panoramic image capture system 100 is illustrated that includes a camera 101 that has a camera lens 103 and an integral flash unit 105. A mirror 107 is offset from the camera lens 103 by a mirror support 109. The one-shot panoramic image capture system 100 is supported by a camera support structure 111. In operation, a light ray 113 is reflected by the mirror 107 to the camera lens 103 where the light ray 113 is captured by the camera 101.

The mirror 107 generally is rotationally symmetric around the axis formed by the mirror support 109. Thus, a panoramic scene surrounding the mirror 107 is captured by the camera 101 as an annular image.

If the integral flash unit 105 on the camera is used, visible light emitted from the integral flash unit 105 will strike the mirror 107, be reflected to the lens and cause overexposed regions and other exposure artifacts in the captured annular image. This can also be true of an external flash within the field of view of the lens that is directed toward the lens.

The camera support structure 111 is often a tripod or other structure that supports the camera 101.

FIG. 2 illustrates a second one-shot panoramic image capture system 200 that includes a transparent refractive case 201 that covers a reflective surface 203. In this system, a light ray 205 is refracted by the transparent refractive case 201 to the reflective surface 203 that reflects the light ray 205 down an optical support column 207 to the camera lens 103 where the light ray 205 can be captured by the camera 101.

The optical support column 207 can include lenses to correct optical aberrations resulting from the refraction and reflection of the light ray 205 and to optimize the light for capture by the camera 101. Such a panoramic lens is disclosed, for example, in U.S. patent application Ser. No. 09/175,157 entitled “Panoramic Imaging Arrangement” filed “Oct. 19, 1998” now U.S. Pat. No. 6,341,044. Again, as with the catadioptric lens of FIG. 1, activation of the integral flash unit 105 will cause exposure artifacts in the captured annular image.

FIG. 3 illustrates a field-of-view diagram 300 of a lens similar to that shown in FIG. 2. The field-of-view diagram 300 includes a viewpoint 301 (where substantially all light that strikes this point in space is captured if it comes from any direction from 360 degrees around a horizon line 303 and for some number of degrees above and below the horizon line 303. A vertical field of view 305 is the combined angle above and below the horizon line 303. The field-of-view diagram 300 for the lens of FIG. 2 includes a blind area cone 307 both above and below the vertical field of view 305. Light from either blind area cone 307 will not reach the viewpoint 301. The lens shown in FIG. 1 has a different field-of-view diagram, but also has a blind spot (anything behind the mirror 107 or behind the camera 101 and the camera support structure 111).

Similar field-of-view diagrams can be constructed for other lenses.

These systems work well when the ambient light is bright enough to fully illuminate the panoramic scene. A difficulty arises when these systems are used in dim and/or uneven light. For traditional photography, a flash device would be used to increase the illumination of the subject matter of the scene.

However, with these and similar one-shot systems, when the integral flash is used, significant amounts of visible light is directed at the mirror, or lens containing the mirror. The bright flash on the lens/mirror causes exposure artifacts that degrade the quality of the captured annular image as is indicated with FIG. 4. These artifacts include illumination of dust or other dirt on the lens and/or over exposure of portions of the annular image, where light from the flash is directly (as compared to light from the flash being reflected by objects in the panoramic scene to the lens) captured by the lens/mirror and transferred to the image plane. The flash artifacts are indicated in the figure by the black dot.

One way to provide “flash” photography for cameras using a panoramic lens is to place a remote flash in the blind spot of the lens. The problem with this approach is how to trigger the remote flash. If the remote flash is placed in a blind spot opposite the camera body (such as on top of a panoramic lens), the flash cable will be in the panoramic image. If the remote flash is placed next to the camera body, opposite the lens, the remote flash when activated will generate shadows of the camera support structure 111 onto the panoramic scene causing flash generated lighting artifacts in the captured image.

It would be advantageous to use the integral flash on the camera to trigger a separate flash device without degrading the quality of the captured panoramic image and without creating flash-generated lighting artifacts.

### SUMMARY OF THE INVENTION

Embodiments of the inventive method include the steps of activating a first flash unit to emit both visible and invisible light, filtering out the visible light and using the invisible light to trigger a remote flash unit that illuminates a panoramic scene such that an image of the panoramic scene can be captured by a panoramic image capture optical system (for example, a panoramic lens).

Another embodiment includes a camera apparatus that includes an integral flash unit and a panoramic image capture optical system (for example, a panoramic lens) placed such that visible light from the flash unit would be directly captured by the panoramic lens. A visible-light filter is used to block visible light emitted from the integral flash unit while transmitting invisible light. When the integral flash unit is triggered, the emitted invisible light (that is transmitted through the visible-light filter) then triggers a remote flash unit (that is equipped with an invisible light sensor/trigger) that then illuminates the panoramic scene.

Yet another embodiment includes a remote flash unit attached to a panoramic image capture optical system in the blind spot of the optical system.

The foregoing and many other aspects of the present invention will no doubt become obvious to those of ordinary skill in the art after having read the following detailed description of the preferred embodiments that are illustrated in the various drawing figures.

### DESCRIPTION OF THE DRAWINGS

FIG. 1 illustrates a prior art one-shot panoramic image capture system;

FIG. 2 illustrates another prior art one-shot panoramic image capture system;

FIG. 3 illustrates the field of view of the image capture system of FIG. 2;

FIG. 4 illustrates prior art exposure artifacts with an integral flash unit and a panoramic lens;

FIG. 5 illustrates a camera equipped with a panoramic lens and flash device according to a preferred embodiment;

FIG. 6A illustrates a flash reflector for use with a flash device positioned in the blind spot of a panoramic lens in accordance with a preferred embodiment; and

FIG. 6B illustrates a side view of the reflector of FIG. 6A.

### DESCRIPTION OF THE PREFERRED EMBODIMENTS

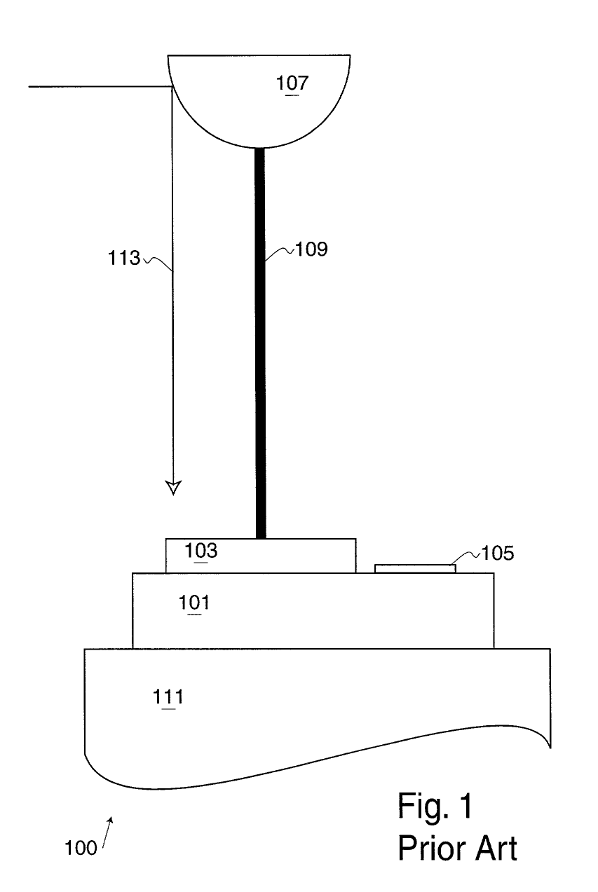

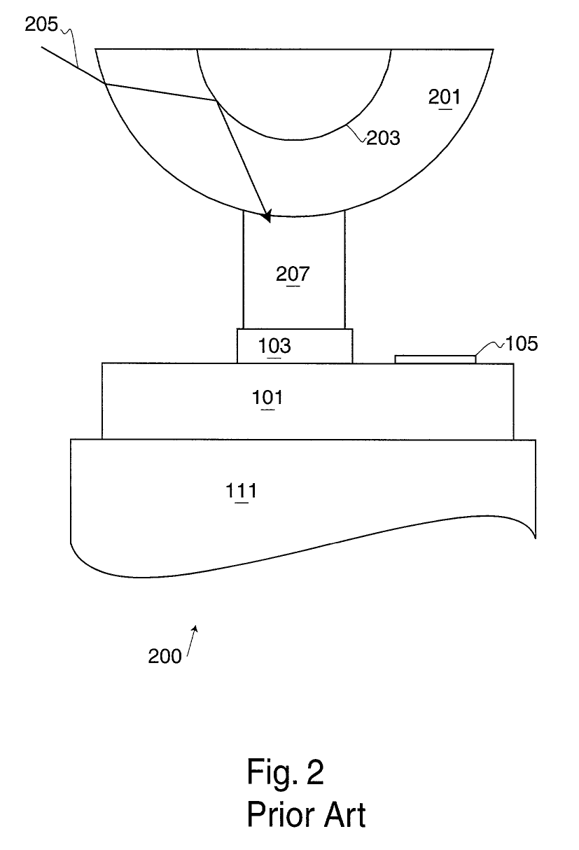

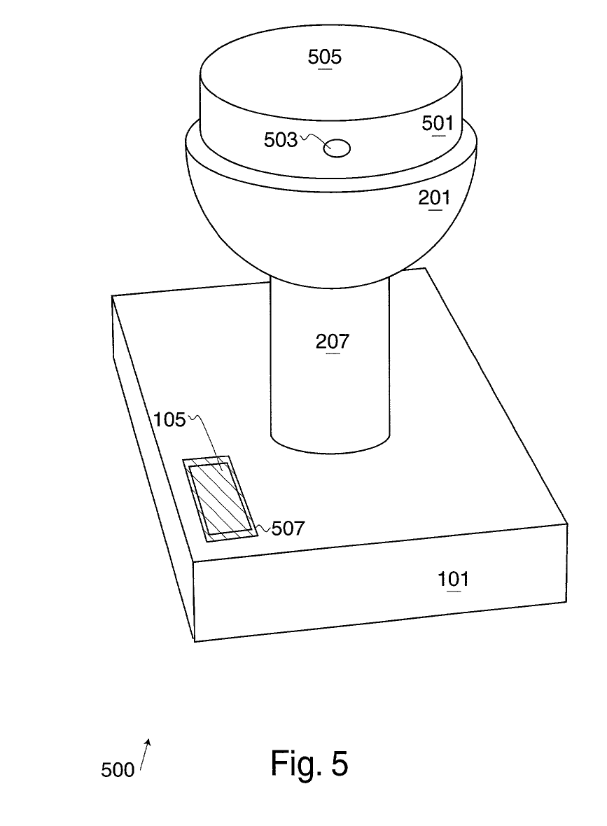

One aspect of the invention is illustrated in FIG. 5 that shows a camera-lens-flash configuration 500 that includes the camera 101 fitted with a panoramic lens or other panoramic image capture optical system (for example, see FIG. 1 and FIG. 2) and in this illustration showing the transparent refractive case 201 and the optical support column 207. In this illustration, a remote flash device 501 is positioned on the distal end of the lens. The remote flash device 501 includes an invisible light sensor 503 (such as an infrared light sensor, or an ultraviolet light sensor) and a flash lens 505 that distributes the light generated by the remote flash device 501 to the environment. In addition, a visible-light filter 507 is placed over the integral flash unit 105 such that visible light is filtered out of the light (or other electromagnetic radiation) emitted from the integral flash unit 105 while allowing non-visible light to pass. By filtering out visible light, the remaining non-visible light can be used to activate the invisible light sensor 503 to trigger the remote flash device 501.

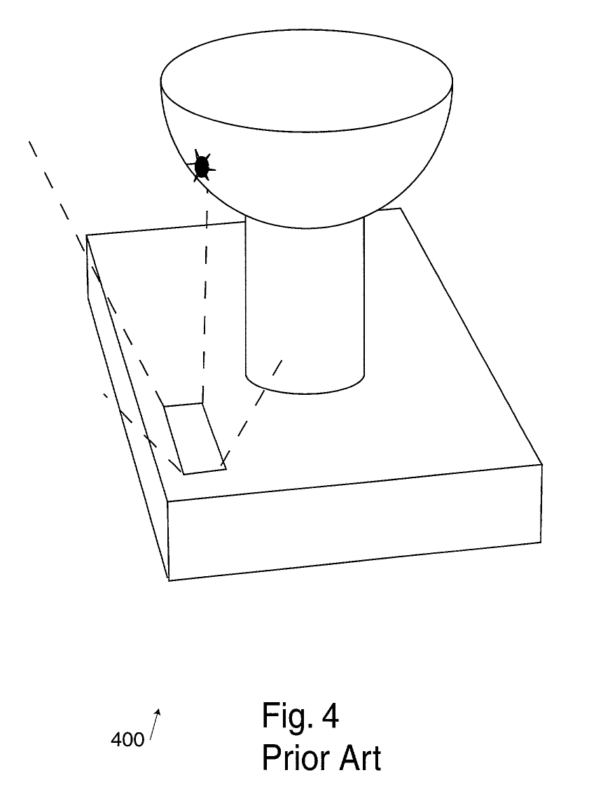

As in FIG. 4, the integral flash unit is positioned relative to the panoramic lens such that if visible light were emitted from the integral flash unit, the emitted visible light would be directly captured by the panoramic lens and impair the quality of the captured panoramic still image by producing flash artifacts on the panoramic lens or other panoramic image capture optical system. These flash artifacts include illuminating surface imperfections (for example, dust) on the lens, overexposure caused by visible light from the flash being directly captured by the panoramic lens and transferred to the focal plane of the image capture device.

The visible-light filter 507 can be in the form of a gelatin filter (for example KODAK WRATTEN® Filter type No. 87) that is taped over the integral flash unit, a filter with an adhesive backing or an object made of the appropriate material that can be placed to cover the integral flash unit (such as a plastic that supports, contains, is attached to, etc. a visible-light filter). The visible-light filter can be in the form of a photographic gel, a photographic gel with an adhesive surface, a glass plate, plastic plate, or a filter element that fits within a filter holder such that substantially all the visible light is filtered out when the integral flash unit is activated. Another preferred embodiment includes a filter clip (made out of plastic or other springy material) that is placed over the integral flash unit and the body of the camera. The portion of the filter clip covering the integral flash unit incorporates the visible-light filter. Other portions of the clip configured to not pass disruptive amounts of visible light. In addition, the visible-light filter 507 can be inserted in a filter holder assembly covering the integral flash unit. Furthermore, the lens of the integral flash unit 105 can be replaced by the visible-light filter 507. One skilled in the art will understand that there are many other equivalent ways to use the visible-light filter 507 to block the visible light while passing the invisible light. Such a one will also understand that there are many equivalent ways to form, attach, and use the visible light filter with the integral flash unit.

In particular, the inventive method for taking a panoramic still image of a panoramic scene using a flash includes steps for configuring an image capture device (such as a camera) that is equipped with a panoramic image capture optical system (such as a panoramic lens as is illustrated in FIG. 1 and FIG. 2) and a first flash (such as a integral flash unit). The first flash, when activated, emits electromagnetic radiation that includes a visible light component and an invisible light component (for example, infrared light or ultraviolet light). The step of configuring can include specifying the relevant camera parameters (such as requiring the integral flash unit to activate).

The integral flash unit lens is covered with a visible-light filter that blocks substantially all of the visible light that is generated when the integral flash unit is triggered while allowing a sufficient portion of the invisible light to be passed through the visible-light filter to trigger at least one remote flash device that, in turn, illuminates a portion of the panoramic scene.

When the image capture device is activated, it triggers the integral flash unit that then emits both visible light and invisible light. Substantially all of the visible light is filtered out by the visible-light filter while allowing sufficient invisible light to be emitted. The invisible light is detected by a sensor that triggers at least one remote flash device. The at least one remote flash device then illuminates all or a portion of the panoramic scene and can also trigger other flash units that respond to the light (either visible or non-visible) emitted from the at least one remote flash device.

The at least one remote flash device can be placed at the distal end of the panoramic lens in a blind spot (as indicated in FIG. 4 or in an area that is not part of the panoramic scene such as behind the lens in FIG. 1). It can also be placed behind objects in the panoramic scene. The remote flash device can be a part of the panoramic lens.

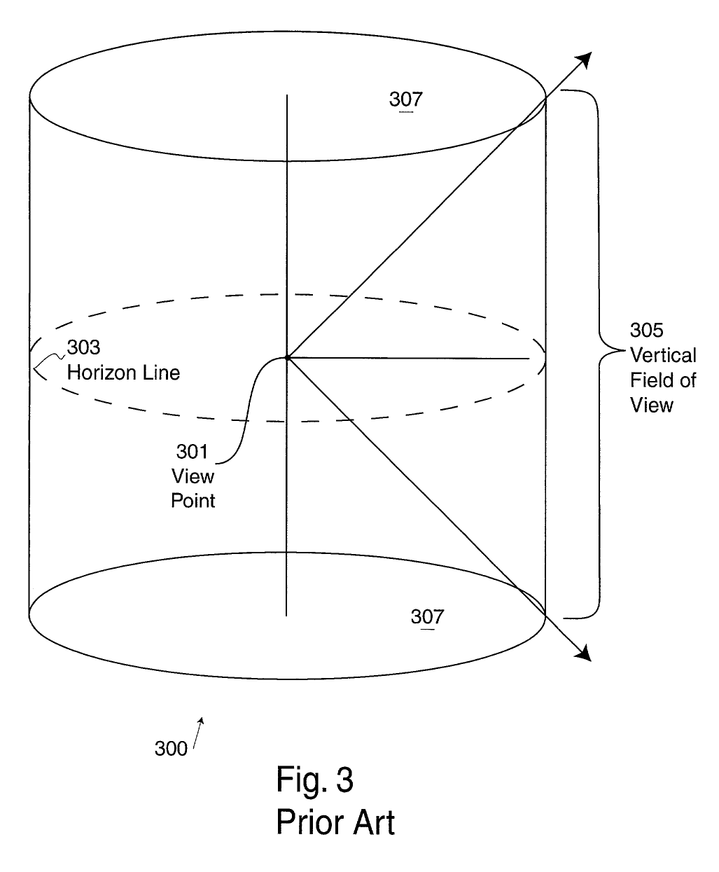

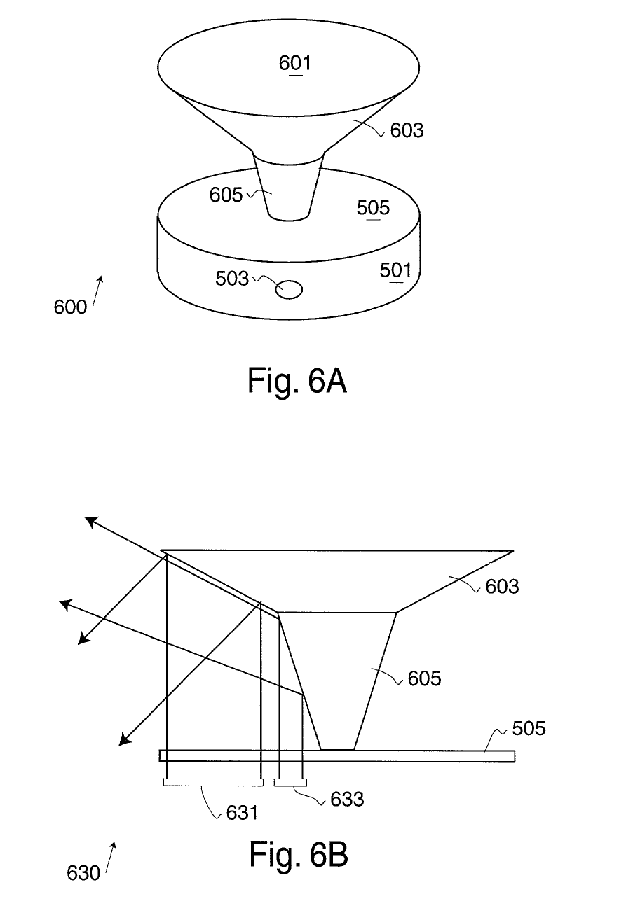

FIG. 6A and FIG. 6B illustrate a panoramic flash reflector 600 that can be used with an upward directed remote flash unit such as the remote flash device 501. The panoramic flash reflector 600 includes a top 601, a first reflecting surface 603, and a second reflecting surface 605. The reflector surfaces can be white or reflective or other so long as the light passing through the flash lens 505 is dispersed throughout substantially all of the field of view of the panoramic image capture optical system both above and below the camera to illuminate the entire field of view of the panoramic lens (see FIG. 3). FIG. 6B illustrates a side view of the reflector 630 indicating light 631 reflected from the first reflecting surface 603 and light 633 reflected from the second reflecting surface 605. One skilled in the art will understand that the light exits the flash lens 505 at many angles and not just perpendicular to the flash lens 505 as is indicated in FIG. 6B. The panoramic flash reflector 600 can also have one or more reflecting surfaces and some or all of these surfaces can be made curved. In addition, the panoramic flash reflector 600 is designed to scatter light from the remote flash throughout the field-of-view for the panoramic image capture optical system being used.

One skilled in the art will understand that the invention allows one-shot panoramic flash photography using the integral camera flash where the visible light from the integral flash is blocked while non-visible light is passed; and where a remote flash is triggered by the passed non-visible light.

From the foregoing, it will be appreciated that the invention has (without limitation) the following advantages:

1) The captured panoramic image does not have support structure shadows.

2) The captured panoramic image does not include images of cables used to connect the flash to the camera (where the first flash is integral with the camera).

3) The captured panoramic image does not include flash-related artifacts on the lens or mirror.

4) The camera and panoramic lens can be used with a flash unit to enable flash photography.

Although the present invention has been described in terms of the presently preferred embodiments, one skilled in the art will understand that various modifications and alterations may be made without departing from the scope of the invention. Accordingly, the scope of the invention is not to be limited to the particular invention embodiments discussed herein.

What is claimed is:

1. A method for triggering at least one remote flash device when capturing a panoramic still image of a panoramic scene, said method comprising steps of:
configuring an image capture device, said image capture device including a panoramic image capture optical system and a first flash, said first flash capable of emitting both visible light and invisible light, said first flash and said panoramic image capture optical system positioned such that said visible light if emitted would be directly captured by the panoramic image capture optical system, said first flash covered by a visible-light filter, said visible-light filter capable of blocking said visible light while passing a sufficient portion of said invisible light;
placing at least one remote flash device to illuminate at least a portion of the said panoramic scene, said at least one remote flash device capable of being triggered by detection of said invisible light; and
triggering said first flash, whereby said sufficient portion of said invisible light is passed through said visible-light filter to trigger said at least one remote flash device that in turn illuminates at least a portion of said panoramic scene for capture.

2. The method of claim 1 further comprising a step of applying said visible-light filter over said first flash.

3. The method of claim 1 wherein said visible-light filter is attached with adhesive tape.

4. The method of claim 1 wherein said visible-light filter includes an adhesive.

5. The method of claim 1 wherein said visible-light filter is fitted over said first flash within a filter holder.

6. The method of claim 1 wherein said visible-light filter is clipped over said first flash.

7. The method of claim 1 wherein said at least one remote flash device is positioned in a blind spot of the panoramic image capture optical system.

8. The method of claim 1 wherein said at least one remote flash device further comprises a light dispersal reflector configured to disperse visible light emitted from said at least one remote flash device to illuminate said panoramic scene in accordance to the field-of-view of the panoramic image capture optical system.

9. The method of claim 1 wherein, the first flash is integral with the image capture device.

10. An apparatus comprising:
an image capture device;
a panoramic image capture optical system attached to the image capture device;
a first flash capable of emitting both visible light and invisible light, the first flash and the panoramic image capture optical system positioned such that said visible light if emitted would be directly captured by the panoramic image capture optical system;
a visible-light filter, said visible-light filter configured to block said visible light from the first flash while passing a sufficient portion of said invisible light; and
at least one remote flash device configured to illuminate at least a portion of the panorama, said at least one remote flash device capable of being triggered by detection of said invisible light.

11. The apparatus of claim 10 wherein said visible-light filter is attached with adhesive tape.

12. The apparatus of claim 10 wherein said visible-light filter includes an adhesive.

13. The apparatus of claim 10 wherein said visible-light filter is positioned over said first flash.

14. The apparatus of claim 10 wherein said at least one remote flash device is positioned in a blind spot of the panoramic image capture optical system.

15. The apparatus of claim 10 wherein said at least one remote flash device further comprises a light dispersal reflector configured to disperse visible light emitted from said at least one remote flash device to illuminate said panoramic scene in accordance to the field-of-view of the panoramic image capture optical system.

16. The apparatus of claim 10 wherein, the first flash is integral with the image capture device.

17. A panoramic lens comprising:
a panoramic image capture optical system configured to capture light from a panoramic scene and capable of being optically connected to an image capture device, the panoramic image capture optical system having a field-of-view with a blind spot; and
at least one remote flash device attached to the panoramic image capture optical system within said blind spot and the at least one remote flash device capable of being triggered by invisible light.

18. The panoramic lens of claim 17 wherein the at least one remote flash device comprises an infrared light sensor and said invisible light being infrared light.

19. The panoramic lens of claim 17 wherein said at least one remote flash device further comprises a light dispersal reflector configured to disperse visible light emitted from said at least one remote flash device to illuminate said panoramic scene in accordance to the field-of-view of the panoramic image capture optical system.
